(19) United States
(12) Patent Application Publication
(10) Pub. No.: US 2017/0209953 A1
(43) Pub. Date: Jul. 27, 2017

(54) Welding Unit

(71) Applicant: PLASSER & THEURER EXPORT VON BAHNBAUMASCHINEN GESELLSCHAFT M.B.H., WIEN (AT)

(72) Inventor: RONALD STEINER, RABENSTEIN AN DER PIELACH (AT)

(21) Appl. No.: 15/329,605

(22) PCT Filed: Jul. 3, 2015
(86) PCT No.: PCT/EP2015/001365

§ 371 Date: Jan. 27, 2017

(30) Foreign Application Priority Data
Jul. 28, 2014 (AT) A 592/2014

(51) Int. Cl. B23K 11/04; E01B 11/50; E01B 29/46; B23K 11/00

(52) U.S. Cl. CPC B23K 11/046; B23K 11/002; E01B 11/50; E01B 29/46

(57) ABSTRACT

A welding unit for connecting two rails of a track by flash-butt welding, includes clamping jaws having contact surfaces intended for application to a rail web and a power jaw for current transmission having a contact surface for application to the rail web. The power jaw is displaceable relative to the clamping jaw in a pressing direction leading to contact with the rail. In an inoperative position spaced from the rail web, the power jaw, due to the pressure of a pressure spring, is situated in a forward end position with regard to the pressing direction, in which the contact surface of the power jaw projects beyond the contact surface of the clamping jaw.

The invention relates to a welding unit for connecting two rails of a track by flash-butt welding, the welding unit having clamping jaws comprising contact surfaces intended for application to a rail web.

A welding unit of this type is known from WO 2010/063362 A1. The clamping jaws, each having two contact surfaces spaced from one another, serve on the one hand for producing a maximal force lock between the rail and the welding unit, and on the other hand also for current transmission.

It is the object of the present invention to provide a welding unit of the kind mentioned at the beginning with which an improved current transmission is possible.

According to the invention, this object is achieved with a welding unit of the specified type by way of the features cited in the characterizing clause of the main claim.

Due to this combination of features, the advantage is achieved of having a pressing force which is constant as well as optimal for the transmission of current. Additionally, it is possible without problems to grind away any traces of wear occurring on the contact surfaces of the power jaws, without thereby detracting from the above-mentioned advantages.

Additional advantages of the invention become apparent from the dependent claim and the drawing description.

The invention will be described in more detail below with reference to an embodiment represented in the drawing in which

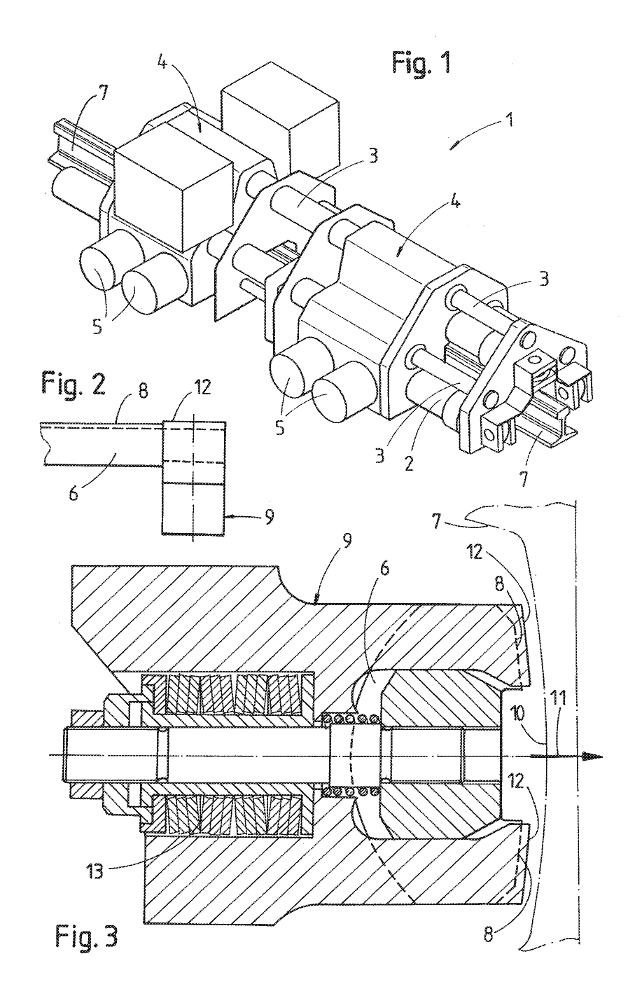

FIG. 1 shows a view of a welding unit,

FIG. 2 shows a top view of a clamping- and power jaw, and

FIG. 3 shows a cross-section of the power jaw.

A welding unit 1, represented in FIG. 1, for connecting two rails 7 of a track by means of flash-butt welding is composed of two unit components 4 which are displaceable with respect to one another along assembly guides 3 with the aid of displacement cylinders 2. Each of said unit parts 4 is connected to two clamping drives 5 by means of which clamping jaws 6 (not visible here, see FIGS. 2, 3) can be pressed onto the rails 7 to be welded to one another.

The clamping jaw 6 shown in FIGS. 2 and 3 has contact surfaces 8 intended for application to a rail web 10. One end of the clamping jaw 6 is connected to a power jaw 9 which is made of copper and provided for the transmission of current. Said power jaw 9 is displaceable relative to the clamping jaw 6—in a pressing direction 11 toward the rail 7—and has contact surfaces 12 intended for application to the rail web 10.

The power jaw 9 which is pre-stressed by the pressure of a spring 13, preferably a disc spring, is situated in a forward end position in the pressing direction 11, in which the contact surface 12 of the power jaw 9—when in an inoperative position spaced from the rail web 10 (see FIG. 3)—projects beyond the contact surface 8 of the clamping jaw 6. Thus, a constant contact pressure of the power jaw 9 against the rail web 10 is ensured as soon as the clamping jaw 6 is pressed to the rail 7. In an advantageous manner, it is furthermore possible to regrind the contact surfaces 12 of the power jaw 9 several times in order to thereby eliminate slight damages of the surface to maintain the smallest possible contact transmission resistance.

As can be seen in FIG. 3, the power jaw 9 is fastened directly to the clamping jaw 6 and pre-stressed in the pressing direction 11 by the pressure of the spring 13. As soon as the clamping jaw 6 is pressed against the rail web 10 for initiating a welding process, there is an automatic backwards movement of the power jaw 9 opposite to the pressing direction 11, until the two contact surfaces 8 and 12 are positioned in a common plane.

1-2. (canceled)

3. A welding unit for interconnecting two rails of a track by flash-butt welding, the welding unit comprising:
a) clamping jaws having contact surfaces to be applied to a rail web;
b) a power jaw provided for current transmission, said power jaw having a contact surface to be applied to the rail web;
c) said power jaw being displaceable relative to said clamping jaws in a pressing direction leading to contact with the;
d) a pressure spring for applying pressure to said power jaw; and
e) said power jaw, in an inoperative position spaced from the rail web, being pressed by said pressure of said pressure spring into a forward end position in said pressing direction causing said contact surface of said power jaw to project beyond said contact surfaces of said clamping jaws.

4. The welding unit according to claim 3, wherein said power jaw is fastened directly to said clamping jaws and is displaceable relative to said clamping jaws in said pressing direction.
